(19) United States
(12) Patent Application Publication
(10) Pub. No.: US 2023/0314592 A1
(43) Pub. Date: Oct. 5, 2023

(54) Electronic Devices With Radar

(71) Applicant: Apple Inc., Cupertino, CA (US)

(72) Inventors: Lijun Zhang, Los Gatos, CA (US); Jiangfeng Wu, San Jose, CA (US); Mattia Pascolini, San Francisco, CA (US); Siwen Yong, San Francisco, CA (US); Yi Jiang, Cupertino, CA (US)

(21) Appl. No.: 18/172,895

(22) Filed: Feb. 22, 2023

Related U.S. Application Data
(63) Continuation of application No. PCT/US2021/048274, filed on Aug. 30, 2021.
(60) Provisional application No. 63/075,665, filed on Sep. 8, 2020.

(51) Int. Cl. G01S 13/86; G01S 7/03; G06F 1/16

(52) U.S. Cl. CPC G01S 13/86; G01S 7/03; G01S 13/867; G06F 1/163; G01S 2013/0263

(57) ABSTRACT

A head-mounted device may have a head-mounted housing. A radar sensor may be mounted in the housing. The head-mounted housing may have rear-facing displays that display images for a user. The images are viewable from eye boxes while the head-mounted device is being worn by the user. A forward-facing camera may capture real-world image content. The rear-facing displays may be used to display captured real-world image content merged with computer-generated image content. The forward-facing camera and the radar sensor may be mounted under inactive display borders of a forward-facing display. The radar sensor may have a horizontal array of patch antenna elements configured to form a phased antenna array. Communications circuitry in the head-mounted device may use the phased antenna array to transmit and receive wireless communications signals.

This application is a continuation of international patent application No. PCT/US2021/048274, filed Aug. 30, 2021, which claims priority to U.S. provisional patent application No. 63/075,665, filed Sep. 8, 2020, which are hereby incorporated by reference herein in their entireties.

### FIELD

This relates generally to electronic devices, and, more particularly, to electronic devices such as head-mounted devices.

### BACKGROUND

Electronic devices such as head-mounted devices may have displays for displaying images. The displays may be housed in a head-mounted support structure.

### SUMMARY

A head-mounted device may have a head-mounted housing. A radar sensor may be mounted in the housing. The head-mounted housing may have rear-facing displays that display images for a user. The images are viewable from eye boxes while the head-mounted device is being worn by the user. A forward-facing camera may capture real-world image content. The rear-facing displays may be used to display the captured real-world image content merged with computer-generated image content.

Control circuitry in the head-mounted device may be used to analyze data from sensors such as the forward-facing camera and radar sensor. In the event that the radar sensor detects an obstruction that is transparent to the forward-facing camera, the control circuitry can issue an alert for the user or can take other suitable action. The alert may be issued visually on the rear-facing displays or may be issued as a haptic or audio alert (as examples).

The forward-facing camera and the radar sensor may be mounted under inactive display border regions of a forward-facing display. The radar sensor may have a horizontal array of patch antenna elements configured to form a phased antenna array. Communications circuitry in the head-mounted device may use the phased antenna array to transmit and receive wireless communications signals.

### BRIEF DESCRIPTION OF THE DRAWINGS

FIG. 1 is a side view of an illustrative electronic device such as a head-mounted device in accordance with an embodiment.

FIG. 2 is schematic diagram of an illustrative system with an electronic device in accordance with an embodiment.

FIG. 3 is a diagram of illustrative radio-frequency circuitry with a phased antenna array for supporting radar sensing and optional communications operations in an electronic device in accordance with an embodiment.

FIG. 4 is a front view of an illustrative antenna array in accordance with an embodiment.

FIG. 5 is cross-sectional side view of an illustrative electronic device with an antenna array in accordance with an embodiment.

FIG. 6 is a front view of an illustrative electronic device with an antenna array in accordance with an embodiment.

FIG. 7 is a diagram of an illustrative electronic device operating in an environment with a transparent object that may be sensed by a radar sensor in accordance with an embodiment.

FIG. 8 is a flow chart of illustrative operations involved in using an electronic device in accordance with an embodiment.

### DETAILED DESCRIPTION

Head-mounted devices include head-mounted support structures that allow the devices to be worn on the heads of users. Displays may be used for presenting a user with visual content. A head-mounted device may have rear-facing displays that display images to the user while the head-mounted device is being worn. The head-mounted device may also have a publicly viewable front-facing display.

Sensors may be used to gather information on the environment surrounding a head-mounted device. The sensors may include one or more visible-light and/or infrared cameras that face forward. Forward-facing visible and/or infrared cameras may be used to gather two-dimensional and/or three-dimensional images of a user's surroundings.

Forward-facing camera images of the real world may be merged with computer-generated content. For example, computer-generated objects may be merged with real-world images from a forward-facing camera so that the computer-generated objects appear to from part of the real world. Three-dimensional image information may be used to locate real-world objects in three-dimensional space. This information may be used to align computer-generated objects with real-world objects in images that are presented to a user.

Not all real-world objects are easily detectable by visible light and infrared cameras. For example, transparent walls in buildings may be challenging to detect using visible and infrared cameras. To help identify the locations of these potential obstructions, the head-mounted device may be provided with radar sensors. The radar sensors may sense the location of objects in the environment surrounding the user, including structures that are transparent and not detectable to cameras such as transparent walls and windows. Radar sensor information may be used in combination with three-dimensional images or other optical sensor information to locate objects in three-dimensional space (e.g., to help in aligning computer-generated content with elements in a real-world image) and/or can be used to issue alerts or for taking other actions.

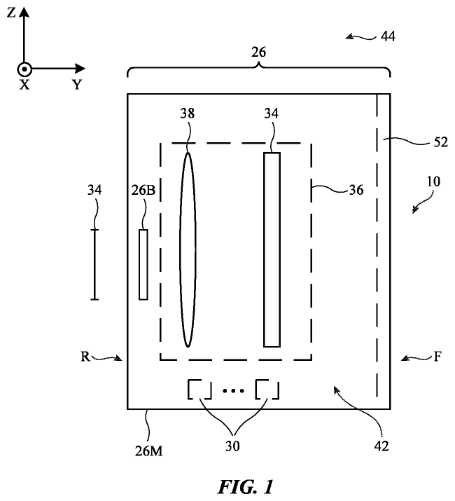

FIG. 1 is a side view of an illustrative head-mounted electronic device. As shown in FIG. 1, head-mounted device 10 may include head-mounted support structure 26. Support structure 26, which may sometimes be referred to as a housing or enclosure, may have walls or other structures that separate an interior region of device 10 such as interior region 42 from an exterior region surrounding device 10 such as exterior region 44. Electrical components 30 (e.g., integrated circuits, sensors, control circuitry, input-output devices, etc.) may be mounted on printed circuits and/or other structures within device 10 (e.g., in interior region 42).

To present a user with images for viewing from eye boxes such as eye box 34, device 10 may include displays such as display 14 and lenses such as lens 38. These components may be mounted in optical modules such as optical module 36 (e.g., a lens barrel) to form respective left and right optical systems. There may be, for example, a left display for presenting an image through a left lens to a user's left eye in a left eye box and a right display for presenting an image to a user's right eye in a right eye box. The user's eyes are located in eye boxes 34 when rear face R of structure 26 rests against the outer surface of the user's face.

Support structure 26 may include a main housing support structure such as portion 26M. Main housing portion 26M may have a portion on front face F of device 10. A forward-facing publicly viewable display such as display 52 may be mounted on front face F of portion 26M. Display 52 may face away from rear-facing displays 14. Display 52 may lie generally in the X-Z plane of FIG. 1. If desired, display 52 on front face F of device 10 may curve slightly about the Z axis of FIG. 1 (e.g., to accommodate the curved shape of a user's face).

Support structure 26 may include optional head straps (sometimes referred to as headbands) such as strap 26B and/or other head-mounted support structures that are configured to extend around the head of the user to help support device 10 on the head of the user during use.

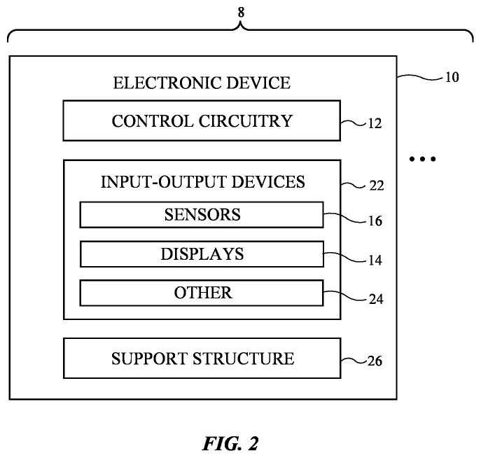

A schematic diagram of an illustrative system that may include a head-mounted device is shown in FIG. 2. As shown in FIG. 2, system 8 may have one or more electronic devices 10. Devices 10 may include a head-mounted device (e.g., device 10 of FIG. 1), accessories such as headphones, associated computing equipment (e.g., a cellular telephone, tablet computer, laptop computer, desktop computer, and/or remote computing equipment that supplies content to a head-mounted device), and/or other devices that communicate with the head-mounted device.

Each electronic device 10 may have control circuitry 12. Control circuitry 12 may include storage and processing circuitry for controlling the operation of device 10. Circuitry 12 may include storage such as hard disk drive storage, nonvolatile memory (e.g., electrically-programmable-read-only memory configured to form a solid-state drive), volatile memory (e.g., static or dynamic random-access-memory), etc. Processing circuitry in control circuitry 12 may be based on one or more microprocessors, microcontrollers, digital signal processors, baseband processors, power management units, audio chips, graphics processing units, application specific integrated circuits, and other integrated circuits. Software code may be stored on storage in circuitry 12 and run on processing circuitry in circuitry 12 to implement control operations for device 10 (e.g., data gathering operations, operations involving the adjustment of the components of device 10 using control signals, etc.). Control circuitry 12 may include wired and wireless communications circuitry. For example, control circuitry 12 may include radio-frequency transceiver circuitry such as cellular telephone transceiver circuitry, wireless local area network transceiver circuitry (e.g., WiFi® circuitry), millimeter wave transceiver circuitry, and/or other wireless communications circuitry.

To support interactions with external equipment, control circuitry 12 may be used in implementing communications protocols. Communications protocols that may be implemented using control circuitry 12 include internet protocols, wireless local area network protocols (e.g., IEEE 802.11 protocols—sometimes referred to as Wi-Fi®), protocols for other short-range wireless communications links such as the Bluetooth® protocol or other wireless personal area network (WPAN) protocols, IEEE 802.11ad protocols, cellular telephone protocols, multiple-input and multiple-output (MIMO) protocols, antenna diversity protocols, satellite navigation system protocols such as global positioning system (GPS) protocols and global navigation satellite system (GLONASS) protocols, IEEE 802.15.4 ultra-wideband communications protocols or other ultra-wideband communications protocols, etc.

During operation, the communications circuitry of the devices in system 8 (e.g., the communications circuitry of control circuitry 12 of device 10) may be used to support communication between the electronic devices. For example, one electronic device may transmit video data, audio data, and/or other data to another electronic device in system 8. Electronic devices in system 8 may use wired and/or wireless communications circuitry to communicate through one or more communications networks (e.g., the internet, local area networks, etc.). The communications circuitry may be used to allow data to be received by device 10 from external equipment (e.g., a tethered computer, a portable device such as a handheld device or laptop computer, online computing equipment such as a remote server or other remote computing equipment, or other electrical equipment) and/or to provide data to external equipment.

Device 10 may include input-output devices 22. Input-output devices 22 may be used to allow a user to provide device 10 with user input. Input-output devices 22 may also be used to gather information on the environment in which device 10 is operating. Output components in devices 22 may allow device 10 to provide a user with output and may be used to communicate with external electrical equipment.

As shown in FIG. 2, input-output devices 22 may include one or more displays such as displays 14. In some configurations, device 10 includes left and right display devices. Device 10 may, for example, include left and right components such as left and right scanning mirror display devices or other image projectors, liquid-crystal-on-silicon display devices, digital mirror devices, or other reflective display devices, left and right display panels based on light-emitting diode pixel arrays (e.g., organic light-emitting display panels or display devices based on pixel arrays formed from crystalline semiconductor light-emitting diode dies), liquid crystal display panels, and/or or other left and right display devices that provide images to left and right eye boxes for viewing by the user's left and right eyes, respectively.

During operation, displays 14 may be used to display visual content for a user of device 10. The content that is presented on displays 14 may include virtual objects and other content that is provided to displays 14 by control circuitry 12. This virtual content may sometimes be referred to as computer-generated content. Computer-generated content may be displayed in the absence of real-world content or may be combined with real-world content. In some configurations, a real-world image may be captured by a camera (e.g., a forward-facing camera, sometimes referred to as a front-facing camera) so that computer-generated content may be electronically overlaid on portions of the real-world image (e.g., when device 10 is a pair of virtual reality goggles).

Input-output circuitry 22 may include sensors 16. Sensors 16 may include, for example, three-dimensional sensors (e.g., three-dimensional image sensors such as structured light sensors that emit beams of light and that use two-dimensional digital image sensors to gather image data for three-dimensional images from light spots that are produced when a target is illuminated by the beams of light, binocular three-dimensional image sensors that gather three-dimensional images using two or more cameras in a binocular imaging arrangement, three-dimensional light detection and ranging sensors, sometimes referred to as lidar sensors, three-dimensional radio-frequency sensors, or other sensors that gather three-dimensional image data), cameras (e.g., infrared and/or visible digital image sensors), gaze tracking sensors (e.g., a gaze tracking system based on an image sensor and, if desired, a light source that emits one or more beams of light that are tracked using the image sensor after reflecting from a user's eyes), touch sensors, capacitive proximity sensors, light-based (optical) proximity sensors, other proximity sensors, force sensors (e.g., strain gauges, capacitive force sensors, resistive force sensors, etc.), sensors such as contact sensors based on switches, gas sensors, pressure sensors, moisture sensors, magnetic sensors, audio sensors (microphones), ambient light sensors, microphones for gathering voice commands and other audio input, sensors that are configured to gather information on motion, position, and/or orientation (e.g., accelerometers, gyroscopes, compasses, and/or inertial measurement units that include all of these sensors or a subset of one or two of these sensors), and/or other sensors. If desired, sensors 16 may include radio-frequency sensors such as radar sensors operating in one dimension, two dimensions, or three dimensions, ultrawideband (UWB) sensors, and/or other sensors using radio-frequency signals (e.g., microwave signals).

User input and other information may be gathered using sensors and other input devices in input-output devices 22. If desired, input-output devices 22 may include other devices 24 such as haptic output devices (e.g., vibrating components), light-emitting diodes and other light sources, speakers such as ear speakers for producing audio output, circuits for receiving wireless power, circuits for transmitting power wirelessly to other devices, batteries and other energy storage devices (e.g., capacitors), joysticks, buttons, and/or other components.

Electronic device 10 may have head-mounted support structures such as head-mounted support structure 26 (e.g., head-mounted housing structures such as housing walls, straps, etc.). The head-mounted support structure may be configured to be worn on a head of a user (e.g., against the user's face covering the user's eyes) during operation of device 10 and may support displays 14, sensors 16, other components 24, other input-output devices 22, and control circuitry 12 (see, e.g., components 30 and optical module 36 of FIG. 1).

To made radar measurements, ultrawideband sensor measurements (e.g. measurements that locate other devices in the vicinity of device 10 by analyzing the time-of-flight and/or orientation of signals transmitted by other devices to device 10), and/or other radio-frequency measurements, and/or to support wireless communications, device 10 may have wireless circuitry that operates at microwave frequencies (e.g., 300 MHz to 300 GHz, 1-100 GHz, super high frequencies from 30-30 GHz, extremely high frequencies from 30-300 GHz, etc.). Directionality may be achieved in these measurements and/or communications operations using one or more phased antenna arrays. For example, a phased antenna array may be used to scan a transmitted beam in various directions. During signal reception operations, the phased antenna array can be adjusted to scan the direction of maximum signal reception sensitivity in various directions. Rader signals (e.g., reflections of transmitted radar signals) can be analyzed to determine the distance (range) of real-world objects to device 10. By using both radar distance measurements and radar directional information (e.g., radar signal orientation determined by beamforming with a phased antenna array), the radio-frequency circuitry of device 10 can gather two-dimensional or three-dimensional radar maps of the environment surrounding device 10.

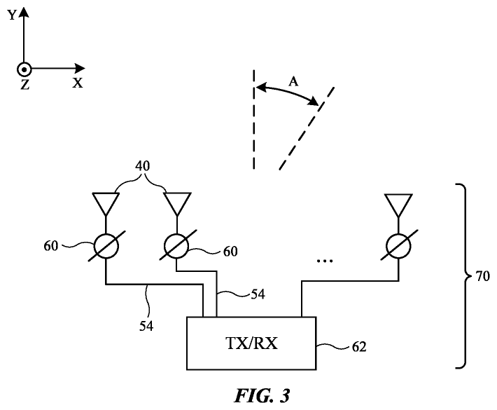

Illustrative radio-frequency circuitry for device 10 is shown in FIG. 3. Wireless circuitry 70 may be used for sensing operations (e.g., radar sensing, etc.) and may therefore be used in forming one or more sensors 16. Circuitry 70 may also be used for communications operations and may therefore form part of the communications and control circuitry of device 10 such as circuitry 12 of FIG. 2.

As shown in FIG. 3, wireless circuitry 70 may include antennas 40 that are coupled to circuitry for transmitting and/or receiving wireless signals such as transceiver circuitry 62 by transmission lines 54. In some configurations, circuitry 70 may be used for communications. For example, circuitry 62 may include wireless local area network (WLAN) and wireless personal area network (WPAN) transceiver circuitry. Transceiver circuitry 62 may handle 2.4 GHz and 5 GHz bands for WiFi® (IEEE 802.11) communications or other WLAN bands and may handle the 2.4 GHz Bluetooth® communications band or other WPAN bands. Circuitry 62 may also include cellular telephone transceiver circuitry for handling wireless communications in frequency ranges (communications bands) between 600 MHz and 6 GHz and/or other cellular communications bands such as a cellular low band (LB) from 600 to 960 MHz, a cellular low-midband (LMB) from 1410 to 1510 MHz, a cellular midband (MB) from 1710 to 2170 MHz, a cellular high band (FIB) from 2300 to 2700 MHz, a cellular ultra-high band (UHB) from 3300 to 5850 MHz, other communications bands between 600 MHz and 5850 MHz (e.g., a frequency between 600 MHz and 6 GHz), or other suitable frequencies (as examples). The cellular telephone transceiver circuitry may handle voice data and non-voice data. If desired, wireless communications may be performed at frequencies such as frequencies of 1-300 GHz, 3-30 GHz (sometimes referred to as a super high frequency band), 30-300 GHz (sometimes referred to as an extremely high frequency band), at 60 Hz, 10-or other frequencies.

Circuitry 62 may include satellite navigation system circuitry such as Global Positioning System (GPS) receiver circuitry for receiving GPS signals at 1575 MHz or for handling other satellite positioning data (e.g., GLONASS signals at 1609 MHz). Satellite navigation system signals for circuitry 62 are received from a constellation of satellites orbiting the earth. Circuitry 62 can include circuitry for other short-range and long-range wireless links if desired. For example, circuitry 62 may include circuitry for receiving television and radio signals, paging system transceivers, near field communications (NFC) transceiver circuitry (e.g., an NFC transceiver operating at 13.56 MHz or another suitable frequency), etc.

In NFC links, wireless signals are typically conveyed over a few inches at most. In satellite navigation system links, cellular telephone links, and other long-range links, wireless signals are typically used to convey data over thousands of feet or miles. In WLAN and WPAN links at 2.4 and 5 GHz and other short-range wireless links, wireless signals are typically used to convey data over tens or hundreds of feet. Antenna diversity schemes may be used if desired to ensure that the antennas that have become blocked or that are otherwise degraded due to the operating environment of device 10 can be switched out of use and higher-performing antennas used in their place.

To gather information on the locations of objects in the real-world environment surrounding device 10, circuitry 70 may be used to support radar measurements and ultrawideband (UWB) measurements.

For example, transceiver circuitry 62 may include ultra-wideband (UWB) transceiver circuitry that supports communications using the IEEE 802.15.4 protocol and/or other ultra-wideband communications protocols. In an IEEE 802.15.4 system, a pair of electronic devices may exchange wireless time stamped messages. Time stamps in the messages may be analyzed to determine the time of flight of the messages and thereby determine the distance (range) between the devices and/or an angle between the devices (e.g., an angle of arrival of incoming radio-frequency signals). UWB transceiver circuitry in circuitry 62 may operate at one or more ultra-wideband communications frequencies between about 5 GHz and about 8.3 GHz, between 3 GHz and 10 GHz, and/or at other frequencies (e.g., a 6.5 GHz UWB communications band, an 8 GHz UWB communications band, and/or bands at other suitable frequencies). As an example, device 10 may transmit and/or receive radio-frequency signals at ultra-wideband frequencies with external wireless equipment to determine a distance between device 10 and the external wireless equipment and/or to determine an angle of arrival of radio-frequency signals (e.g., to determine the relative orientation and/or position of the external wireless equipment with respect to device 10). The external wireless equipment may be an electronic device in system 8 such as device 10 or may include any other desired wireless equipment. Radio-frequency signals handled by device 10 in an ultra-wideband communications band and using an ultra-wideband communications protocol may sometimes be referred to herein as ultra-wideband signals. Radio-frequency signals transmitted and/or received by device 10 in other communications bands (e.g., using communications protocols other than an ultra-wideband communications protocol) may sometimes be referred to here as non-ultra-wideband (non-UWB) signals. Non-UWB signals handled by device 10 may include, for example, radio-frequency signals in a cellular telephone communications band, a WLAN communications band, etc.

Radar measurements with circuitry 70 involve using transceiver 62 to transmit and receive radar signals (e.g., microwave signals, signals at a frequency between 1 GHz and 300 GHz, 3-30 GHz, 30-300 GHz, 60 GHz, 50-70 GHz, or other suitable radar signals). Emitted radar signals reflect from real-world objects. These reflections are sensed using circuitry 62. By processing radar signal reflections (e.g., by calculating the time of flight of signals that reflect from objects and/or by otherwise processing transmitted and received radar signals), circuitry 70 can determine the location of the objects.

As shown in FIG. 3, circuitry 70 may include multiple antennas 40. Antennas 40 may include a one-dimensional or two-dimensional array of antennas. The antennas of the antenna array may have associated phase shifters 60 that can be controlled by control circuitry 12. Using beamforming techniques (e.g., by adjusting phase shifters 60), the direction in which radar signals (or other radio-frequency) signals are transmitted and received by circuitry 70 can be adjusted. For example, beam steering techniques may be used to sweep or otherwise adjust the angle A of a beam with respect to the Y axis of FIG. 3. Circuitry 70 may, be used to scan in one dimension (e.g., when antennas 40 form a one-dimensional array that extends horizontally in the X dimension or vertically in the Y dimension) or may be used to scan in two-dimensions (e.g., when antennas 40 form a two-dimensional array that extends both horizontally and vertically).

Antennas 40 may be formed using any suitable types of antenna structures. For example, antennas 40 may include antennas with resonating elements that are formed from loop antenna structures, patch antenna structures, inverted-F antenna structures, slot antenna structures, planar inverted-F antenna structures, helical antenna structures, dipole antenna structures, monopole antenna structures, hybrids of two or more of these designs, etc. If desired, one or more of antennas 40 may be cavity-backed antennas. In an illustrative configuration, patch antenna resonating elements may be used for antennas 40 that handle radar signals (e.g. radar signals at 60 GHz or other suitable frequencies).

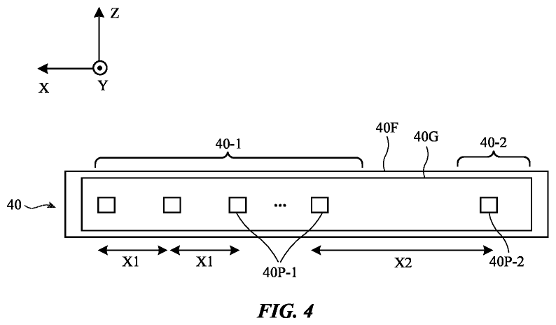

An illustrative one-dimensional radar antenna array that may be used in circuitry 70 of FIG. 3 is shown in FIG. 4. As shown in FIG. 4, an array of antennas 40 may be formed on a substrate such as substrate 40F. Substrate 40F may be a printed circuit substrate (e.g. an elongated strip of polymer or other dielectric forming a flexible printed circuit or rigid printed circuit) or may formed from other dielectric substrate materials (e.g., rigid polymer that is molded and/or machined into a desired shape, glass, ceramic, and/or other dielectric materials). An antenna ground structure for antennas 40 such as antenna ground 40G may be supported on substrate 40F. Ground 40G may, for example, be a ground plane that is formed from metal traces on substrate 40F. Metal traces on another layer of substrate 40F (e.g. a layer that is at a different Y position in the example of FIG. 4) may be patterned to form patch antenna resonating elements for antennas 40.

Antennas 40 may include receiver patch antennas 40-1 and transmitter patch antenna 40-2. Antennas 40-1 may be formed from ground 40G and respective receiver patch elements 40P-1 that are spaced apart from each other by distance X1. Distance X1 may be equal to one half of the wavelength of the radar signal to facilitate beam forming operations. Antenna 40-2 may be formed from antenna ground 40G and transmitter patch element 40P-2, which is spaced apart from the closest of patch elements 40P-1 in the receiver antenna array by a distance X2. Distance X2 may be equal to two wavelengths of the radar signal to help isolate radar transmitting antenna 40-2 from receiver antenna array 40-1.

In the example of FIG. 4, antennas 40 include a one-dimensional receiver antenna array formed from a horizontal row of antennas 40-1 and include a single transmitting antenna 40-2. With this type of arrangement, the location of objects in the environment can be determined by gathering (1) time-of-flight measurements indicating the distance of the objects from device 10 and (2) angular orientation information on the received reflected radar signals. The angular information in the FIG. 4 example is gathered using beam forming operations (e.g., by adjusting adjustable phase shifters such as phase shifters 60 for each of receiver antennas 40-1 to adjust angle A of the phased antenna array formed by antennas 40) while sensing reflected radar signals. Arrangements in which transmitted signals are scanned across the environment (e.g., using transmitted beam forming operations and an array of transmit antennas) may also be used. The configuration of FIG. 4 is illustrative. Moreover, the antenna array of FIG. 4 has receiver elements 40P-1 that are arranged in a line (e.g., a one-dimensional antenna array). If desired, a two-dimensional array of antennas 40 (receiver antennas, transmitter antennas, and/or both receiver and transmitter antennas) may be used. The use of an array of receiver antennas and a single transmitter antenna may help reduce the complexity of the radar sensor. The use of separate transmit and receive antennas may help prevent cross-talk.

The antenna array formed from antennas 40 of FIG. 4 may be located at any suitable location within device 10. In an illustrative configuration, the antenna array is formed under a front portion of device 10 so that the radar sensor gathers information on objects in front of device 10. Side sensing and/or rearwardly sensing radar sensors can also be provided, if desired.

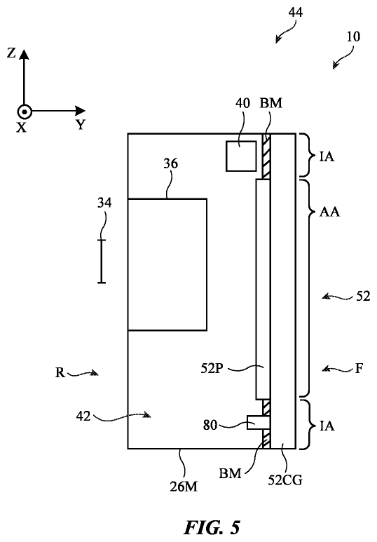

FIG. 5 is a cross-sectional side view of an illustrative head-mounted device with a forward-facing radar sensor formed from an array of antennas 40. As shown in FIG. 5, antennas 40 may be mounted in interior region 42 of portion 26M of support structure 26. Optical modules 36 may face rearwardly from rear face R of device 10 toward aligned eye boxes 34. Front-facing display 52 may be formed on opposing front face F of device 10. Display 52 may have an active area AA that contains a pixel array (sometimes referred to as a display panel) such as display panel 52P. Display panel 52P may have organic light-emitting diode pixels, liquid crystal display pixels, or other array of pixels for displaying an image in active area AA.

An inactive border region such as inactive area IA may run along some or all of the peripheral edge of active area AA. Display cover layer 52CG may overlap display panel 52P in active area AA and may overlap inactive area IA. Display cover layer 52CG may be formed from transparent glass, clear polymer, crystalline materials such as sapphire, and/or other transparent materials. In inactive area IA, the inner surface of display cover layer 52CG may be covered with opaque masking layer BM (e.g., a layer of black ink or other opaque materials) to hide internal components from view. One or more openings may be formed in opaque masking layer BM to accommodate components such as component 80 (e.g., forward-facing cameras). These openings may be formed along the upper edge of display 52, along the lower edge of display 52, and/or on the sides of display 52 (as examples).

To ensure that the radar sensor associated with the array of antennas 40 is able to satisfactorily gather information on objects in front of the user as the user is walking through a building or other environment, antennas 40 may be located behind opaque masking layer BM in a part of inactive area IA, as shown in FIG. 5. Layer BM is transparent to radar signals, but visibly opaque to hide radar sensor structures from view from exterior region 44. Radar sensor antennas may, as an example, be arranged in a horizontal row in inactive area IA that extends horizontally along the upper peripheral edge of display 52.

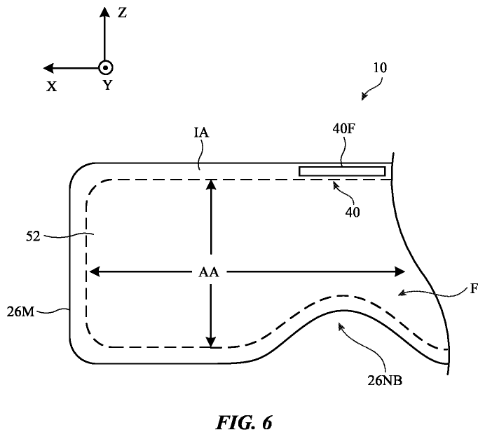

FIG. 6 is a front view of device 10 of FIG. 1, showing how an antenna array formed from antennas 40 (e.g., an array of radar antennas such as the antenna array of FIG. 4 that includes a substrate such as substrate 40F) may be formed along the upper edge of display 52 in inactive area IA. Substrate 40F and the phased antenna array formed from antennas 40 on substrate 40F may have an elongated strip shape that extends horizontally parallel to the X axis of FIG. 6. If desired, the antenna array can extend in other directions (e.g., vertically). Horizontal antenna arrays can sweep a radar beam to the left and right across the area in front of a user. This may help the radar sensor identify obstacles in front of the user such as clear walls or doors that might not be visible to a non-radar sensor.

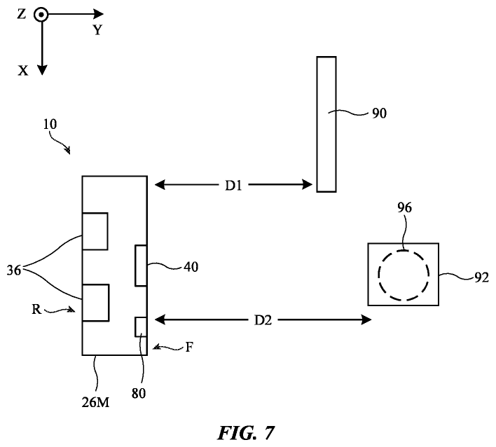

FIG. 7 shows how a user may be provided with alerts and/or how other actions may be taken based on radar sensor information. As shown in the top view of FIG. 7, device 10 may face external real-world objects in front of device 10. These objects may include, for example, object 90 and object 92. Object 90 may be, as an example, a transparent wall in a building or other transparent obstruction. Object 92 may be a piece of furniture such as a table that is visible to the forward-facing cameras of device 10. The radar sensor formed from the phased antenna array (antennas 40) may be located along the upper edge of main housing portion 26M on front face F. This sensor may use radar measurements (e.g., analysis of radar signal reflections) to determine the location of external objects in external region 44. For example, radar sensor measurements may determine that object 92 is located at a distance D2 from device 10 and that object 90 is located at a closer distance D1 from device 10.

Forward-facing (front-facing) visible and/or infrared cameras (see, e.g., components 80) may be used to gather information on the environment surrounding device 10. For example, forward-facing cameras may be used to capture images of objects such as object 92. Using information from the radar sensor formed from antennas 40 and/or using images captured with the forward-facing cameras, device 10 (e.g., control circuitry 12) can determine the location of object 92. This allows device 10 to display computer-generated content in alignment with object 92. As an example, virtual object 96 may overlap object 92 (e.g. virtual object 96 may be located at a virtual image distance D2 from device 10 and/or may be displayed so as to visually align with a planar upper surface of object 92 or other portion of object 92).

Because object 90 is transparent, it may be difficult or impossible for forward facing cameras in device 10 to detect object 90. Accordingly, a user who is walking through a building or other environment in which object 90 is located, may not be able to see object 90 on rear-facing displays 14, even when front-facing camera images are being displayed on displays 14 in real time to recreate the real-world (or at least part of the real-world environment) for the user. To ensure that the user does not inadvertently contact object 90 as the user moves, radar sensor readings may be monitored to measure distance D1 in real time. If the measured value of D1 (or value of D1 predicted from the user's current movements) becomes lower than a predetermined threshold distance or if other suitable alert criteria are satisfied, the user may be presented with an alert. For example, a visual alert on displays 14 and/or an audible alert presented using speakers in device 10 may be generated. The alert may inform the user that transparent wall or other object 90 is close to the user. As an example, the user may be presented with text “warning! you are approaching an obstruction” or an icon or other representation of the radar-detected object may be displayed on displays 14. By using a phased antenna array for the radar sensor, device 10 can determine where object 90 is located horizontally relative to device 10 (e.g., the angular position of object 90 may be determined relative to the X axis). Time-of-flight measurements on the radar signals may reveal the value of distance D1 of object 90 in front of device 10.

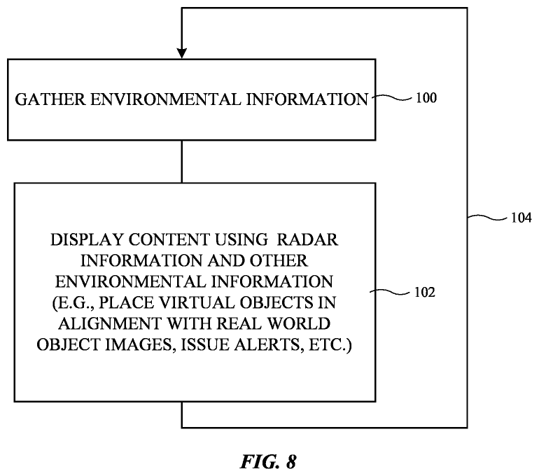

FIG. 8 is a flow chart of illustrative operations associated with using device 10. As shown in FIG. 8, during the operations of block 100, sensors 16 may be used to gather information on the environment surrounding device 10. For example, forward-facing cameras may be used to capture images of real-world objects in exterior region 44. These images may include, for example, real-time forward-facing visible-light images of the real world. Three-dimensional image sensors may, if desired, be used to capture three-dimensional images.

In addition to capturing camera images, sensors 16 such as a radar sensor formed from an array of antennas 40 may be used in gathering radar sensor measurements. These radar measurements may be used, for example, to determine the locations in region 44 of nearly-transparent objects and transparent objects (e.g., objects that are difficult or impossible to detect using cameras).

During the operations of block 102, the user may be presented with visual output on displays 14 of optical modules 36. This visual output may include, for example, images from front-facing image sensors (e.g., an image of the real-world in front of the user). In addition to real-world images, device 10 may display computer-generated content. In some scenarios, virtual images may be aligned with objects in real-world images.

Camera images may not reveal the presence of transparent objects (e.g., glass doors, glass walls, windows, and other transparent objects may not appear in in camera images.). By using radar data, however, device 10 can determine the locations of such transparent objects. During the operations of block 102, computer-generated images (e.g., false color images or icons) that represent the radar-detected visually-transparent objects may be displayed as an overlay on top of the displayed real-world images. By merging radar location information visually with images of the real world, a user may be quickly and accurately informed of potential obstructions in the user's path that are invisible to the forward-facing cameras. Alerts regarding obstructions may include visual alerts on displays 14, audible alerts played through speakers in device 10, haptic alerts created by vibrating haptic output device in device 10, and/or other alerts.

To prevent the excessive issuance of alerts, device 10 may, if desired, exclusively or nearly exclusively issue alerts in connection with radar detection of transparent or nearly transparent objects (e.g., objects that are invisible or nearly invisible to visible and/or infrared cameras). By limiting alert generation to situations in which radar-detected obstructions are transparent or are otherwise obscured to visible and/or infrared image sensors, alerts are only issued when the issuance of the alerts will be of immediate interest to the user. This helps reduce the frequency of alerts and allows individual alerts to be more noticeable to the user. Device 10 can compare radar-based object location data with visual image object location data to determine when radar-sensed obstructions are transparent to the forward-facing cameras. With this approach, alerts may be issued when transparent obstructions are detected using radar and are not issued when obstructions are visible in captured images (e.g., when the obstructions are present in images being displayed in real time on displays 14 for the user even if the obstructions are also detected with radar).

If desired, wireless circuitry 70 may be used to support wireless communications (e.g., communications at 60 GHz and/or other frequencies supported by antennas 40) during the operations of block 102. As an example, one or more antennas in the phased antenna array used for radar measurements may be used to transmit and/or receive wireless communications signals.

As shown by line 104, the operations of blocks 100 and 102 may be performed continuously as the user wears device 10 and interacts with the environment surrounding device 10.

In accordance with an embodiment, a head-mounted device is provided that includes a head-mounted support structure having a rear face and an opposing front face; rear-facing displays that are supported by the head-mounted support structure and that are configured to provide images viewable from eye boxes; and a radar sensor formed from an array of antennas on the front face.

In accordance with another embodiment, the head-mounted device includes forward-facing cameras on the front face, the rear-facing displays are configured to display real-world content from the forward-facing cameras merged with computer-generated content; and the rear-facing displays are configured to display a visual alert in response to detecting an obstacle with the radar sensor that is invisible to the forward-facing cameras.

In accordance with another embodiment, the head-mounted device includes a forward-facing display having a display cover layer and an array of pixels, the forward-facing display has an active area in which the display cover layer overlaps the array of pixels and has an inactive border area without pixels and the radar sensor is in the inactive border area.

In accordance with another embodiment, the array of antennas includes a horizontal row of antenna elements extending along an upper peripheral edge of the front-facing display.

In accordance with another embodiment, the horizontal row of antenna elements includes a horizontal row of patch antenna elements, the radar sensor is configured to transmit and receive a radar signal, and the horizontal row of patch antenna elements includes a plurality of receiver patch antenna elements spaced apart from each other by a half of a wavelength of the radar signal.

In accordance with another embodiment, the horizontal row of patch antenna elements includes a transmitter patch antenna element spaced apart from a nearest one of the receiver patch antenna elements by two wavelengths of the radar signal.

In accordance with another embodiment, the array of antennas is configured to form a phased antenna array.

In accordance with another embodiment, the radar sensor includes a phased antenna array.

In accordance with another embodiment, the radar sensor is configured to operate at a frequency of 60 GHz.

In accordance with another embodiment, the radar sensor includes an array of patch antennas and the head-mounted device includes wireless communications circuitry configured to transmit and receive wireless communications signals using the patch antennas.

In accordance with another embodiment, the radar sensor is configured to operate at a frequency of 60 GHz.

In accordance with another embodiment, the head-mounted device includes a forward-facing display configured to face away from the rear-facing displays, the array of patch antennas includes a one-dimensional strip of patch antennas extending along an upper edge of the forward-facing display.

In accordance with an embodiment, a head-mounted device is provided that includes a head-mounted support structure; left and right displays that are supported by the head-mounted support structure and that are configured to provide images viewable from respective left and right eye boxes; and a forward-facing camera configured to capture a real-world image, the left and right displays are configured to display computer-generated content merged with the captured real-world image; a forward-facing display configured to face away from the left and right displays; and a radar sensor including a phased antenna array that extends along a peripheral edge of the forward-facing display.

In accordance with another embodiment, the radar sensor is configured to transmit and receive a radar signal and the radar sensor includes receiver antenna elements that are spaced apart from each other by half of a wavelength of the radar signal.

In accordance with another embodiment, the radar sensor includes a single transmitter antenna element that is spaced apart from an adjacent one of the receiver antenna elements by two wavelengths of the radar signal.

In accordance with another embodiment, the radar signal has a frequency of 60 GHz.

In accordance with another embodiment, the head-mounted device includes wireless communications circuitry configured to transmit and receive wireless communications signals using the phased antenna array.

In accordance with another embodiment, the head-mounted device includes control circuitry configured to: identify an obstacle that is detected by the radar sensor and that is invisible to the forward-facing camera; and issue an alert in response to identifying the obstacle.

In accordance with an embodiment, a head-mounted device is provided that includes a forward-facing camera configured to capture a real-world image; a rear-facing display configured to display the captured real-world image merged with computer-generated content; a forward-facing display cover layer; and a radar sensor configured to operate through the forward-facing display cover layer.

In accordance with another embodiment, the forward-facing display cover layer has a first portion that overlaps a pixel array, has a second portion that overlaps the forward-facing camera, and has a third portion that overlaps the radar sensor.

In accordance with another embodiment, the radar sensor has a phased antenna array formed from a strip of patch antennas configured to operate at 60 GHz, the head-mounted device including communications circuitry configured to transmit and receive wireless communications circuitry using the phased antenna array.

The foregoing is merely illustrative and various modifications can be made to the described embodiments. The foregoing embodiments may be implemented individually or in any combination.

What is claimed is:

1. A head-mounted device, comprising:
a head-mounted support structure having a rear face and an opposing front face;
rear-facing displays that are supported by the head-mounted support structure and that are configured to provide images viewable from eye boxes; and
a radar sensor formed from an array of antennas on the front face.

2. The head-mounted device defined in claim 1 further comprising forward-facing cameras on the front face, wherein:
the rear-facing displays are configured to display real-world content from the forward-facing cameras merged with computer-generated content; and
the rear-facing displays are configured to display a visual alert in response to detecting an obstacle with the radar sensor that is invisible to the forward-facing cameras.

3. The head-mounted device defined in claim 2 further comprising a forward-facing display having a display cover layer and an array of pixels, wherein the forward-facing display has an active area in which the display cover layer overlaps the array of pixels and has an inactive border area without pixels and wherein the radar sensor is in the inactive border area.

4. The head-mounted device defined in claim 3 wherein the array of antennas comprises a horizontal row of antenna elements extending along an upper peripheral edge of the front-facing display.

5. The head-mounted device defined in claim 4 wherein the horizontal row of antenna elements comprises a horizontal row of patch antenna elements, wherein the radar sensor is configured to transmit and receive a radar signal, and wherein the horizontal row of patch antenna elements includes a plurality of receiver patch antenna elements spaced apart from each other by a half of a wavelength of the radar signal.

6. The head-mounted device defined in claim 5 wherein the horizontal row of patch antenna elements comprises a transmitter patch antenna element spaced apart from a nearest one of the receiver patch antenna elements by two wavelengths of the radar signal.

7. The head-mounted device defined in claim 6 wherein the array of antennas is configured to form a phased antenna array.

8. The head-mounted device defined in claim 2 wherein the radar sensor comprises a phased antenna array.

9. The head-mounted device defined in claim 2 wherein the radar sensor is configured to operate at a frequency of 60 GHz.

10. The head-mounted device defined in claim 1 wherein the radar sensor comprises an array of patch antennas and wherein the head-mounted device further comprises wireless communications circuitry configured to transmit and receive wireless communications signals using the patch antennas.

11. The head-mounted device defined in claim 10 wherein the radar sensor is configured to operate at a frequency of 60 GHz.

12. The head-mounted device defined in claim 11 further comprising:
a forward-facing display configured to face away from the rear-facing displays, wherein the array of patch antennas comprises a one-dimensional strip of patch antennas extending along an upper edge of the forward-facing display.

13. A head-mounted device, comprising:
a head-mounted support structure;
left and right displays that are supported by the head-mounted support structure and that are configured to provide images viewable from respective left and right eye boxes; and
a forward-facing camera configured to capture a real-world image, wherein the left and right displays are configured to display computer-generated content merged with the captured real-world image;
a forward-facing display configured to face away from the left and right displays; and
a radar sensor comprising a phased antenna array that extends along a peripheral edge of the forward-facing display.

14. The head-mounted device defined in claim 13 wherein the radar sensor is configured to transmit and receive a radar signal and wherein the radar sensor comprises receiver antenna elements that are spaced apart from each other by half of a wavelength of the radar signal.

15. The head-mounted device defined in claim 14 wherein the radar sensor comprises a single transmitter antenna element that is spaced apart from an adjacent one of the receiver antenna elements by two wavelengths of the radar signal.

16. The head-mounted device defined in claim 15 wherein the radar signal has a frequency of 60 GHz.

17. The head-mounted device defined in claim 13 further comprising wireless communications circuitry configured to transmit and receive wireless communications signals using the phased antenna array.

18. The head-mounted device defined in claim 13 further comprising:
control circuitry configured to:
identify an obstacle that is detected by the radar sensor and that is invisible to the forward-facing camera; and
issue an alert in response to identifying the obstacle.

19. A head-mounted device, comprising:
a forward-facing camera configured to capture a real-world image;
a rear-facing display configured to display the captured real-world image merged with computer-generated content;
a forward-facing display cover layer; and
a radar sensor configured to operate through the forward-facing display cover layer.

20. The head-mounted device defined in claim 19 wherein the forward-facing display cover layer has a first portion that overlaps a pixel array, has a second portion that overlaps the forward-facing camera, and has a third portion that overlaps the radar sensor.

21. The head-mounted device defined in claim 20 wherein the radar sensor has a phased antenna array formed from a strip of patch antennas configured to operate at 60 GHz, the head-mounted device further comprising communications circuitry configured to transmit and receive wireless communications circuitry using the phased antenna array.
